(19) United States
(12) Patent Application Publication
(10) Pub. No.: US 2008/0301947 A1
(43) Pub. Date: Dec. 11, 2008

(54) Method For Removing Hair, Hair Removal Apparatus and Attachment Therefor

(75) Inventors: Ralf Dorber, Oberursel (DE); Juergen Seng, Kelkheim (DE); Frieder Grieshaber, Neu-Anspach (DE); Xavier Perez-Lopez, Eschborn (DE)

Correspondence Address: FISH & RICHARDSON PC, P.O. BOX 1022, MINNEAPOLIS, MN, 55440-1022, US

(73) Assignee: BRAUN GMBH, Kronberg (DE)

(21) Appl. No.: 12/065,569

(22) PCT Filed: Aug. 24, 2006
(86) PCT No.: PCT/EP2006/008301

§ 371 Date: Aug. 21, 2008

(30) Foreign Application Priority Data
Sep. 19, 2005 (DE) 10 2005 044 737.6

(51) Int. Cl. B26B 19/20; A45D 29/00; B26B 19/00

(52) U.S. Cl. 30/34.05; 132/76.4; 606/133

(57) ABSTRACT

A hair removal apparatus having a housing, a drive mechanism for driving at least a first hair removal unit, and an abrasive element is described. The abrasive element and the first hair removal unit are in close proximity and are equally driven. The abrasive element is arranged and carried in an attachment mountable on and demountable from the housing as an addition to the first hair removal unit.

### TECHNICAL FIELD

This invention relates to a method for removing hair by means of a hair removal apparatus which is to be held in the user's hand and includes at least one hair removal unit for cutting and/or plucking hairs. In addition, the present invention relates to a hair removal apparatus and an attachment for a hair removal apparatus.

### BACKGROUND

From EP 1 225 818 B1 there is known an epilator apparatus which is adapted to be connected to an attachment having an abrasive element. This abrasive element can be oscillated by the drive mechanism of the hair removal appliance. This hair removal appliance thus provides an additional function, enabling it to be used either as an epilator or as an abrading device for the skin.

From U.S. Pat. No. 2,936,768 there is known a manicuring device having a twin work head on which each of the two work units are driven in oscillatory motion. In this device, the one unit is constructed as a shaving head and the other as a manicuring unit arranged parallel thereto. This way it is intended to create a particularly versatile appliance for day-to-day needs. These two known documents both foresee the use of only the one or other work unit, meaning the use of either the hair removal unit or the abrading/manicuring unit.

This means, for example, for the user of a hair removal apparatus according to EP 1 225 818 B1, that after an epilating operation the device referred to as the abrading device must be mounted onto the hair removal apparatus in order then to treat the skin with the abrasive surface in a separate work step. In terms of comfort and expenditure of time, this represents a considerable disadvantage.

### SUMMARY

In one aspect, the invention provides a method for removing hair, a hair removal apparatus and an attachment therefor, with which a particularly thorough removal of hair and treatment of the skin is made possible in a way particularly easy and comfortable for the user. In this case the abrading of the skin by means of the abrasive surface not only smoothes the skin itself but also mechanically processes any remaining hairs, even very short ones, in the sense that they are abraded down or off. Very short hairs remaining after shaving, for example, can be abraded down and thus rounded off on their cut plane, which greatly increases the overall smoothness of the skin surface.

In one aspect of the invention, a hair removal apparatus includes a housing, a drive mechanism, and an abrasive element. The drive mechanism is arranged to drive at least a first hair removal unit and an abrasive element. The abrasive element is arranged proximate the first hair removal unit. The abrasive element is arranged and carried on an attachment mountable on and demountable from the housing.

In another aspect of the invention, an attachment for a hair removal apparatus includes a drivable abrasive element and is mountable on the housing of a hair removal apparatus.

Another aspect of the invention features a method of removing hair from human skin by means of a hair removal apparatus to be held in the user's hand. The hair removal apparatus includes a housing, at least a first hair removal unit for cutting and/or plucking hairs, and an abrasive element. In some implementations, the hair removal unit is brought into contact with the skin and moved along the skin in a feed direction with the abrasive element, also in contact with the skin, being made to follow the hair removal unit in the feed direction.

In some implementations, it is possible to remove hair and smooth the skin in a single operation. An elaborate and time-consuming conversion of the electrical appliance is no longer necessary, nor is another processing cycle after mounting the abrading device.

In this arrangement it is generally possible for the abrasive element to be assigned an additional drive mechanism of its own. According to a preferred embodiment of the invention, provision is made however for the abrasive element to include coupling means which are adapted to engage with mating additional coupling means provided on the hair removal apparatus and connected to the drive mechanism. Hence with simple means the existing drive mechanism in the hair removal apparatus is also used for operating the abrasive element.

The first hair removal unit is preferably a shaving head for cutting hairs. However, the integrated abrading of the skin surface in a single operation also offers an advantage in conjunction with epilating, hence another embodiment of the invention provides for the first hair removal unit to be an epilator head for plucking hairs.

To be able to make a particularly effective impact per pull of the hair removal apparatus across the skin, both in terms of removing hair and smoothing the skin, provision is made in another embodiment of the invention for the hair removal apparatus to have at least two hair removal units. In this arrangement it is particularly advantageous for the first hair removal unit to be constructed as a short-hair cutter unit and the second hair removal unit as a long-hair cutter unit, with the short-hair cutter unit being arranged between the abrasive element and the long-hair cutter unit. As a result, when the hair removal apparatus is moved across the skin with the long-hair cutter unit to the fore, longer hairs are first pre-shortened before the remaining hairs are shaved off with the short-hair cutter unit. Then the shaved area is acted upon by the moving abrasive element and the skin is finally smoothed. For the corresponding application it also makes sense for the first hair removal unit to be constructed as an epilator unit and the second hair removal unit as a long-hair cutter unit, in which case the epilator unit is then arranged between the abrasive element and the long-hair cutter unit. Given the appropriate direction of movement of the hair removal unit relative to the skin surface, the hairs are initially pre-shortened to a certain length so that they can be grasped by the epilator unit easily and close to their roots, thus resulting in a reduction of the pain which may otherwise arise during the plucking. During a single processing pull, the plucking operation is then followed by the smoothing of the skin by means of the abrasive element.

The abrasive element is advantageously driven in oscillatory motion. This is conducive to the easy movement of the hair removal apparatus along the skin. Unwanted, interfering influences on the handling of the hair removal apparatus caused by torques and the interaction of a rotating abrasive disk with the skin can be ruled out from the outset.

If guide or engagement surfaces for contact with the skin are provided on the attachment, then the exact steering of the hair removal apparatus along a desired path on the skin can be made even easier.

It is also possible for both the abrasive element and the second hair removal unit to be arranged in the attachment. Hence it is also possible for a so-called single-head shaver or epilator, meaning a hair removal unit with only one active hair removal unit, to be upgraded by mounting the attachment such that it then has a total of three active units. In particular the second hair removal unit is then constructed as a long-hair cutter unit. Ideally, the active elements are then arranged in the attachment such that, after the attachment is mounted, the first hair removal unit assigned to the hair removal apparatus is arranged between the two units arranged in the attachment, namely the abrasive element and the second hair removal unit.

Further embodiments recited hereinabove with reference to the example of the hair removal apparatus and the attendant advantages also apply accordingly to various implementations of the attachment.

In another aspect of the invention, a method for removing hair from the human skin by means of a hair removal apparatus to be held in the user's hand is characterized in that the hair removal apparatus includes a housing and at least a first hair removal unit for cutting and/or plucking hairs, and in that the hair removal unit is brought into contact with the skin and moved along it in a feed direction, with an abrasive element being made to follow the hair removal unit in the feed direction and being brought likewise into contact with the skin. In this method, it is particularly advantageous for the abrasive element to perform a movement relative to the housing in order to improve the efficiency of the abrading device through said abrading movement being superimposed on the feed movement.

A preferred embodiment of this method provides for a shaving unit to be used as a first hair removal unit. Another embodiment of the invention provides for the use of an epilator unit as a first hair removal unit. For increased efficiency another embodiment of the method of the invention provides for the first hair removal unit to be preceded in the feed direction of the hair removal apparatus by a second hair removal unit, which is constructed preferably as a long-hair cutter unit.

Further objects, features, advantages and application possibilities will become apparent from the subsequent description of embodiments. It will be appreciated that any single feature and any combination of single features described or represented by illustration form the subject-matter of the description.

### DESCRIPTION OF DRAWINGS

In the drawings,

FIG. 1 is a view of the hair removal apparatus with the attachment lifted off;

FIG. 2 is a view of the hair removal apparatus with the attachment mounted and ready for use;

FIG. 3 is a side view of the hair removal apparatus;

FIG. 4 is an enlarged plan view of the attachment; and

FIG. 5 is a sectional view of the attachment and the upper part of the hair removal apparatus with the attachment mounted.

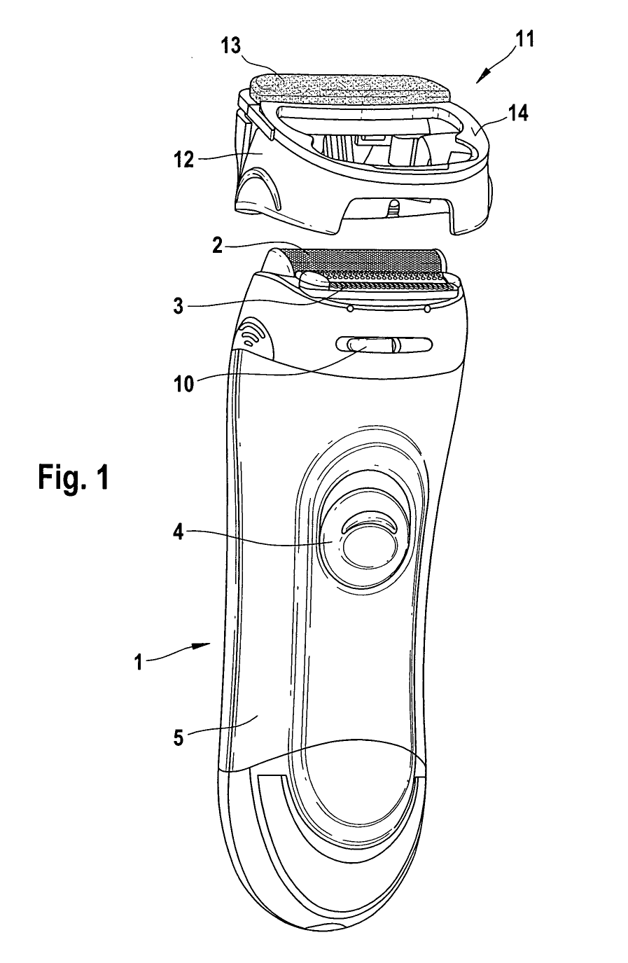

### DETAILED DESCRIPTION

The hair removal apparatus 1 as such is known in the art and is marketed as the Braun LS 5500, Type 5328. It includes a short-hair cutter unit 2 and a long-hair cutter unit 3, which together with the ON/OFF switch 4 are arranged on a housing 5. Also provided in the housing 5 are the power supply and an electric motor, which serve to drive the cutting parts in oscillatory motion. This is not illustrated in the drawings for the sake of clarity. The short-hair cutter unit includes a shaving foil 6 forming the outer cutter, and an under cutter 7, in a manner known in the art. Under cutter 7 includes a plurality of blades moved in oscillating fashion underneath the foil. The long-hair cutter unit 3 in turn has a stationary cutting comb 8, which forms the outer cutter, and an under cutter which is formed by a cutting blade 9 driven in oscillatory motion. These parts of the shaving units are shown in more detail in FIG. 5.

The long-hair cutter unit 3 is elastically biased in upward direction on the whole and is carried in a floating bearing enabling it to follow the skin contour with ease. It can however be locked in place by the lock switch 10 so that it can be better used for the trimming function.

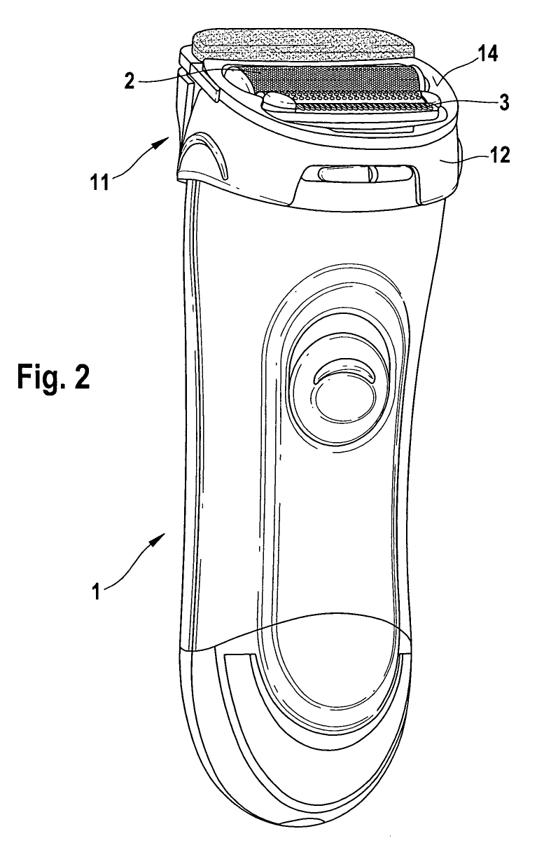

The attachment 11 has an annular supporting body 12 in which the abrasive element 13 is carried such that it can be driven in oscillatory motion along its longitudinal axis. The abrasive element 13 can be constructed as pumice stone, as abrasive paper, as an open-cell sintered part or the like. For mounting, the attachment 11 is seated upon the shaving head of the hair removal apparatus 1 such that it is securely connected to the housing 5 of the hair removal apparatus 1 and such that the cutting elements, i.e., the short-hair cutter unit 2 and the long-hair cutter unit 3, continue to be freely accessible and can be used accordingly. With the attachment 11 seated in place, both the short-hair cutter unit 2 and the long-hair cutter unit 3 project up beyond the essentially annularly circumferential engagement surface 14 constructed on the supporting body 12. This is clearly evident from FIGS. 2 and 5. The supporting body 12 has on its front end a cutout for the lock switch 10 so that said switch can still be accessed and operated even after the attachment 11 is mounted.

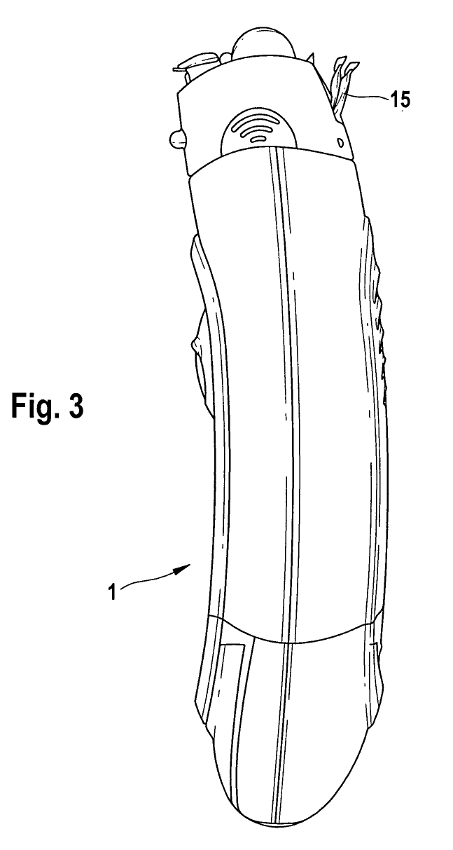

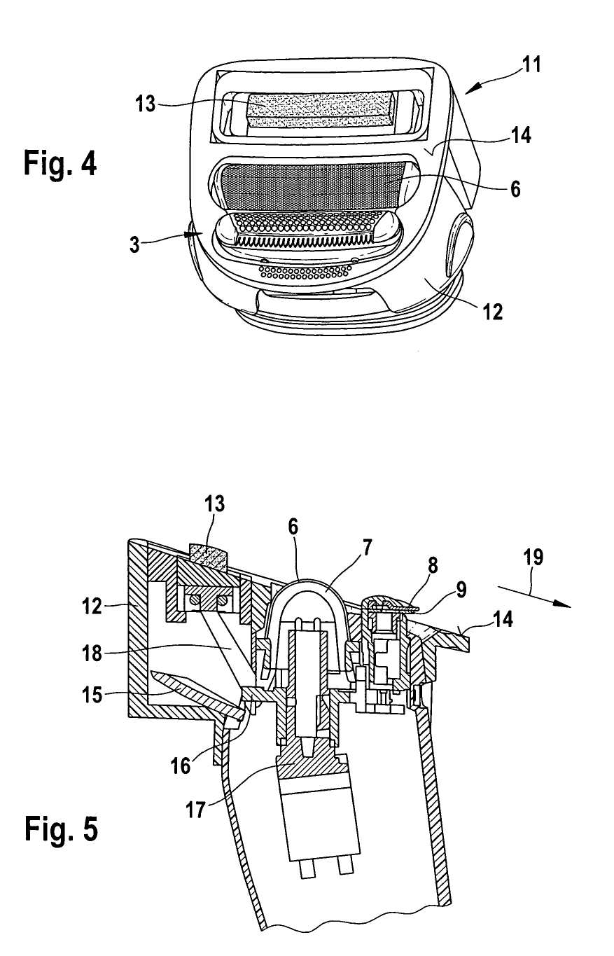

FIG. 3 is a side view of the hair removal apparatus 1 showing the flap 15, which is arranged in the region of the shaving head at the rear of the hair removal apparatus, in open position. Said flap 15, which is adapted to swivel about an axis extending parallel to the longitudinal dimension of the cutting elements and the abrasive element 13 respectively, enables the fork-shaped coupling 16 provided in the interior of the housing 5 and connected to the oscillating bridge 17 of the drive mechanism of the cutting elements 7 and 9 to be covered or exposed. The flap 15 must be opened prior to mounting the attachment 11 so as to enable the coupling finger 18 connected to the abrasive element 13 to be made to engage with the coupling 16 during the mounting operation. Once this engagement is effected, the oscillating movement of the oscillating bridge 17 can be transmitted via the coupling 16 and the coupling finger 18 onto the abrasive element 13, which is mounted in the supporting body 12 for sliding motion along its longitudinal axis. Through suitable construction of the flap and coordination of the geometrical relationships with the coupling finger 18 and the supporting body 12 respectively, it is also possible to ensure that the flap 15 opens automatically upon mounting the attachment 11 on the hair removal apparatus 1.

If the hair removal apparatus 1 with mounted attachment 11 is now brought into contact with the surface of the skin to be treated and moved across the skin in the feed direction 19, i.e., in the direction of the long-hair cutter unit 3, then longer hairs on the skin are first shortened by the long-hair cutter unit 3 and then shaved off by the following short-hair cutter unit 2. Then the shaved skin is finally smoothed by the abrasive element 13 with its oscillating to and fro movement, whereby for example dried or dead skin particles or calluses are also removed. All of the operations described are performed during a single pull of the hair removal apparatus across the skin. If, by contrast, only a shave or hair trim is intended, then the attachment 11 detaches easily in order for the hair removal apparatus 1 to be used in the usual way.

In an example not shown in the drawings, the hair removal unit of the hair removal apparatus 1 is constructed as an epilating head, which uses suitable clamping elements to grip hairs on the skin and remove them. With such a hair removal apparatus it is likewise effective, through corresponding use of an attachment carrying an abrasive element therein, to treat the skin with said abrading device subsequent to an epilating operation. In this case the comfort level is increased if, in addition to the epilating device, use is made of a long-hair cutter unit which precedes the epilating unit, whereby the abrasive element 13 follows the epilating unit. In particularly advantageous manner it is then possible, with a single operation or pull, first for hairs on the skin to be pre-shortened by means of a long-hair cutter unit to a certain length that enables the following epilating device to grip and pluck said hairs effectively and with as little pain as possible, and then for the epilated skin to be treated in the final integrated work step with the abrading device.

1-22. (canceled)

23. A hair removal apparatus comprising:
a housing carrying a driven first hair removal unit; and
a removable attachment mounted on the housing and carrying a driven abrasive element arranged proximate the first hair removal unit.

24. The hair removal apparatus according to claim 23, wherein the abrasive element and the first hair removal unit are driven by a common drive mechanism.

25. The hair removal apparatus according to claim 23, wherein the first hair removal unit is a shaving head that cuts hairs.

26. The hair removal apparatus according to claim 23, wherein the first hair removal unit is an epilator head that plucks hairs.

27. The hair removal apparatus according to claim 23, further comprising a second hair removal unit.

28. The hair removal apparatus according to claim 27, wherein the first hair removal unit is a short-hair cutter unit, and the second hair removal unit is a long-hair cutter unit comprising a stationary cutting comb, with the short-hair cutter unit being arranged between the abrasive element and the long-hair cutter unit.

29. The hair removal apparatus according to claim 28, wherein the short-hair cutter unit comprises a shaving foil.

30. The hair removal apparatus according to claim 27, wherein the abrasive element and the second hair removal unit are carried on the attachment.

31. The hair removal apparatus according to claim 27, wherein at least one of the first hair removal unit, the second hair removal unit, and the abrasive element is retractably mounted and elastically biased in the direction of the skin.

32. The hair removal apparatus according to claim 23, wherein the abrasive element is driven in oscillatory motion.

33. The hair removal apparatus according to claim 23, wherein at least one of the first hair removal unit and the abrasive element is retractably mounted and elastically biased in the direction of the skin.

34. The hair removal apparatus according to claim 23, wherein the attachment comprises guide or engagement surfaces for contact with the skin.

35. The hair removal apparatus according to claim 34, wherein the guide or attachment surfaces allow steering of the hair removal apparatus along a selected path while the apparatus is moved along the skin.

36. A method of removing hair from human skin with a hand-held hair removal apparatus, the method comprising:
bringing the hair removal apparatus into contact with the skin, such that a first hair removal unit and an abrasive element in a housing of the hair removal apparatus are both in contact with the skin; and
moving the hair removal apparatus along the skin in a feed direction such that the abrasive element follows the first hair removal unit in the feed direction.

37. The method according to claim 36, the abrasive element being selected from the group consisting of a pumice stone, abrasive paper, and open-cell sintered material.

38. The method according to claim 36, wherein the abrasive element moves relative to the housing.

39. The method according to claim 36, wherein the first hair removal unit is a shaving head that cuts hairs while the apparatus is moved along the skin.

40. The method according to claim 36, wherein the first hair removal unit is an epilator head that plucks hairs while the apparatus is moved along the skin.

41. The method according to claim 36, wherein the hair removal apparatus comprises a second hair removal unit, and wherein the first hair removal unit is preceded in the feed direction by the second hair removal unit as the apparatus is moved along the skin.

42. The method according to claim 41, wherein the second hair removal unit is a long-hair cutter unit comprising a stationary cutting comb.

43. The method according to claim 36, wherein the first hair removal unit is operable to cut and/or pluck hairs.

44. An attachment for a hair removal apparatus comprising:
an attachment housing configured for releasable mounting to a hair removal apparatus; and
a drivable abrasive element carried by the attachment housing and positioned to be exposed to contact skin during use of a hair removal apparatus to which the housing is mounted, the abrasive element being selected from the group consisting of pumice stone, abrasive paper, and open-cell sintered material.

45. The attachment according to claim 44, wherein the abrasive element is configured to be driven in oscillatory motion by the hair removal apparatus during use.

46. The attachment according to claim 44, further comprising guide or engagement surfaces arranged to contact the skin during use.

47. The attachment according to claim 44, further comprising a hair removal unit.

48. The attachment according to claim 47, wherein at least one of the abrasive element and the hair removal unit is retractably mounted to the housing and elastically biased.
